(19) United States
(12) Patent Application Publication
(10) Pub. No.: US 2013/0115016 A1
(43) Pub. Date: May 9, 2013

(54) QUICK CHANGE HOPPER

(71) Applicant: Graco Minnesota Inc., Minneapolis, MN (US)

(72) Inventors: Daniel P. Ross, Maplewood, MN (US); Paul R. Quam, Brooklyn Center, MN (US)

(73) Assignee: GRACO MINNESOTA INC., Minneapolis, MN (US)

(21) Appl. No.: 13/671,092

(22) Filed: Nov. 7, 2012

Related U.S. Application Data
(60) Provisional application No. 61/556,581, filed on Nov. 7, 2011.

(51) Int. Cl. B65G 51/00

(52) U.S. Cl. CPC B65G 51/00
USPC 406/127

(57) ABSTRACT

An adhesive melt system includes a hopper, a feed system, a valve, and a releasable coupling. The hopper stores hot melt pellets and the valve regulates movement of the pellets from the hopper to the feed system. The feed system delivers the hot melt pellets from the hopper. The releasable coupling allows for connection and disconnection of the hopper to and from the feed system. In one embodiment, the hopper is interchangeable with a second hopper. Both hoppers have a coupling that allows for quick connection to and disconnection from the feed system

### CROSS-REFERENCE TO RELATED APPLICATION(S)

This application is a non-provisional of U.S. Application Ser. No. 61/556,581, filed on Nov. 7, 2011.

### BACKGROUND

The present disclosure relates generally to systems for dispensing hot melt adhesive. More particularly, the present disclosure relates to feed systems for hot melt systems.

Hot melt dispensing systems are typically used in manufacturing assembly lines to automatically disperse an adhesive used in the construction of packaging materials such as boxes, cartons and the like. Hot melt dispensing systems conventionally comprise a material tank, heating elements, a pump and a dispenser. Solid polymer pellets are melted in the tank using a heating element before being supplied to the dispenser by the pump. Because the melted pellets will re-solidify into solid form if permitted to cool, the melted pellets must be maintained at temperature from the tank to the dispenser. This typically requires placement of heating elements in the tank, the pump and the dispenser, as well as heating any tubing or hoses that connect those components. Furthermore, conventional hot melt dispensing systems typically utilize tanks having large volumes so that extended periods of dispensing can occur after the pellets contained therein are melted. However, the large volume of pellets within the tank requires a lengthy period of time to completely melt, which increases start-up times for the system. For example, a typical tank includes a plurality of heating elements lining the walls of a rectangular, gravity-fed tank such that melted pellets along the walls prevents the heating elements from efficiently melting pellets in the center of the container. The extended time required to melt the pellets in these tanks increases the likelihood of “charring” or darkening of the adhesive due to prolonged heat exposure.

The system for dispensing hot melt adhesive utilizes a container such as a hopper for holding solid polymer pellets for dispensation to the material tank for melting. Hoppers are bulky, and are therefore difficult and time consuming to move, load, and/or unload.

### SUMMARY

According to the present invention, an adhesive melt system includes a hopper, a feed system, a valve, and a releasable coupling. The hopper stores hot melt pellets and the valve regulates movement of the pellets from the hopper to the feed system. The feed system transports the hot melt pellets from the hopper. The releasable coupling allows for connection and disconnection of the hopper to and from the feed system.

An adhesive melt system includes an interchangeable first hopper and second hopper, a feed system, and a coupling. The interchangeable first hopper and second hopper store hot melt pellets and the feed system delivers the hot melt pellets from either the first hopper or the second hopper. The coupling allows for connection and disconnection of both the first hopper and second hopper to and from the feed system.

A method of operating a hot melt dispensing system includes attaching a first hopper to a delivery line, opening a valve to allow hot melt pellets from the first hopper to travel to a delivery line, delivering the hot melt pellets from the first hopper to a melter through the delivery line, closing the valve, disconnecting the first hopper from the delivery line, attaching a second hopper to the delivery line, opening a second valve to allow the hot melt pellets from the second hopper to travel to the delivery line, and delivering the hot melt pellets from the second hopper to the melter through the delivery line.

An adhesive melt system includes a hopper, a delivery line, a flow inducer, and a releasable coupling. The hopper stores hot melt pellets and has a valve for regulating movement of the pellets from the hopper. The delivery line delivers hot melt pellets from the hopper and the flow inducer is disposed on the delivery line for inducing a flow of the hot melt pellets along the delivery line. The releasable coupling allows for connection to and disconnection of the hopper from the delivery line.

### BRIEF DESCRIPTION OF THE DRAWINGS

FIG. 1 is a schematic view of a system for dispensing hot melt adhesive.

FIG. 2A is a schematic view a first hopper with a valve open and a coupling connecting the first hopper to a feed system.

FIG. 2B is a schematic view of the first hopper with the valve closed and the first hopper disconnected from the feed system.

FIG. 2C is a schematic view of a second hopper with a valve closed and the second hopper disconnected from the feed system.

FIG. 2D is a schematic view the second hopper with the valve open and the coupling connecting the first hopper to a feed system.

### DETAILED DESCRIPTION

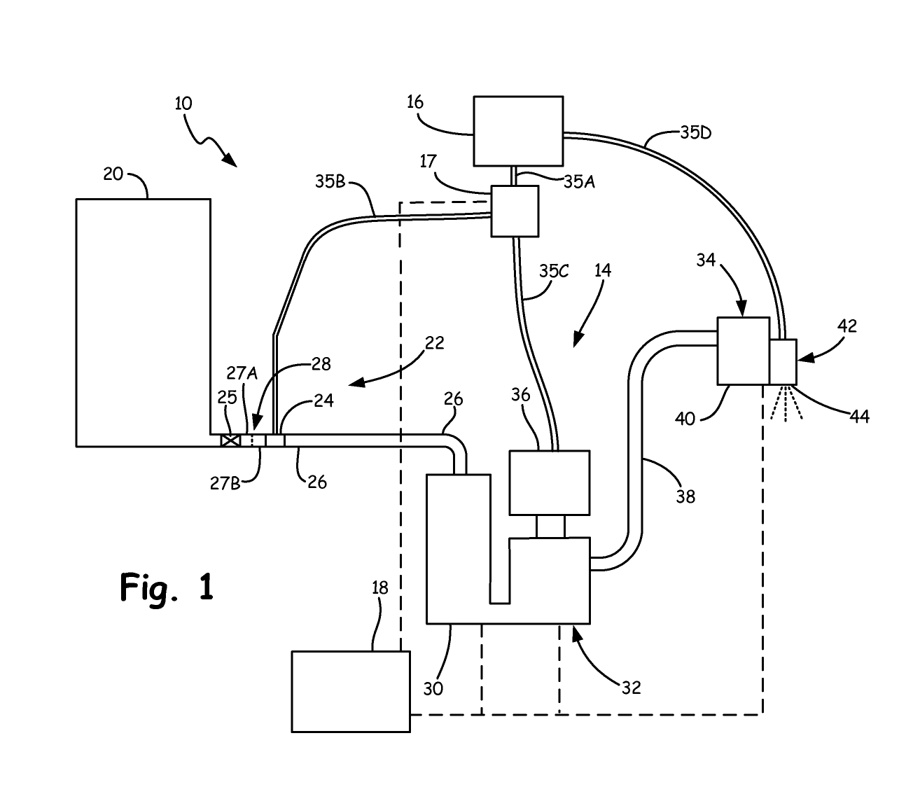

FIG. 1 is a schematic view of system 10, which is a system for dispensing hot melt adhesive. System 10 includes cold section 12, hot section 14, air source 16, air control valve 17, and controller 18. In the embodiment shown in FIG. 1, cold section 12 includes hopper 20 and feed assembly 22. Hopper 20 includes valve 25. Feed assembly 22 includes vacuum assembly 24 and feed hose 26. Coupling 28 connects hopper 20 to feed assembly 22. In particular, coupling 28 includes first coupling part 27A and second coupling part 27B. Coupling parts 27A and 27B are adapted to connect to and disconnect from one another.

In the embodiment shown in FIG. 1, hot section 14 includes melt system 30, pump 32, and dispenser 34. Air source 16 is a source of compressed air supplied to components of system 10 in both cold section 12 and hot section 14. Air control valve 17 is connected to air source 16 via air hose 35A, and selectively controls air flow from air source 16 through air hose 35B to vacuum assembly 24 and through air hose 35C to motor 36 of pump 32. Air hose 35D connects air source 16 to dispenser 34, bypassing air control valve 17. Controller 18 is connected in communication with various components of system 10, such as air control valve 17, melt system 30, pump 32, and/or dispenser 34, for controlling operation of system 10.

Components of cold section 12 can be operated at room temperature, without being heated. Hopper 20 can be a container for holding a quantity of solid adhesive pellets for use by system 10. Suitable adhesives can include, for example, a thermoplastic polymer glue such as ethylene vinyl acetate (EVA) or metallocene.

Hopper 20 can be connected and disconnect to feed assembly 22 with coupling 28. Feed assembly 22 allows solid adhesive pellets to be conveyed to hot section 14. Feed assembly 22 includes vacuum assembly 24 and feed hose 26. Vacuum assembly 24 is positioned along feed assembly 22 adjacent to coupling 28. Compressed air from air source 16 and air control valve 17 is delivered to vacuum assembly 24 to create a vacuum, inducing flow of solid adhesive pellets into inlet of vacuum assembly 24 and then through feed hose 26 to hot section 14. Feed hose 26 is a tube or other passage sized with a diameter substantially larger than that of the solid adhesive pellets to allow the solid adhesive pellets to flow freely through feed hose 26. Feed hose 26 connects vacuum assembly 24 to hot section 14.

Solid adhesive pellets are delivered from feed hose 26 to melt system 30. Melt system 30 can include a container (not shown) and resistive heating elements (not shown) for melting the solid adhesive pellets to form a hot melt adhesive in liquid form. Melt system 30 can be sized to have a relatively small adhesive volume, for example about 0.5 liters, and configured to melt solid adhesive pellets in a relatively short period of time. Pump 32 is driven by motor 36 to pump hot melt adhesive from melt system 30, through supply hose 38, to dispenser 34. Motor 36 can be an air motor driven by pulses of compressed air from air source 16 and air control valve 17. Pump 32 can be a linear displacement pump driven by motor 36. In the illustrated embodiment, dispenser 34 includes manifold 40 and module 42. Hot melt adhesive from pump 32 is received in manifold 40 and dispensed via module 42. Dispenser 34 can selectively discharge hot melt adhesive whereby the hot melt adhesive is sprayed out outlet 44 of module 42 onto an object, such as a package, a case, or another object benefiting from hot melt adhesive dispensed by system 10. Module 42 can be one of multiple modules that are part of dispenser 34. In an alternative embodiment, dispenser 34 can have a different configuration, such as a handheld gun-type dispenser. Some or all of the components in hot section 14, including melt system 30, pump 32, supply hose 38, and dispenser 34, can be heated to keep the hot melt adhesive in a liquid state throughout hot section 14 during the dispensing process.

System 10 can be part of an industrial process, for example, for packaging and sealing cardboard packages and/or cases of packages. In alternative embodiments, system 10 can be modified as necessary for a particular industrial process application. For example, in one embodiment (not shown), pump 32 can be separated from melt system 30 and instead attached to dispenser 34. Supply hose 38 can then connect melt system 30 to pump 32.

In the embodiment shown in FIG. 1, first element 27A is part of hopper 20 while second coupling part 27B is part of feed assembly 22. Having separate coupling parts 27A and 27B and valve 25 allows hopper 20 to be quickly connected to or disconnected from feed assembly 22. In particular, valve 25 can be closed to keep hot melt adhesive pellets from flowing from an outlet of hopper 20 when hopper 20 is disconnected from feed assembly 22. Hopper 20 can be disconnected from feed assembly 22 to be emptied, refilled, or swapped for another container holding the same or different hot melt adhesive pellets. Such a configuration with interchangeable hoppers and couplings allows hot melt adhesive pellets to be quickly swapped or refilled with minimal downtime for the system 10.

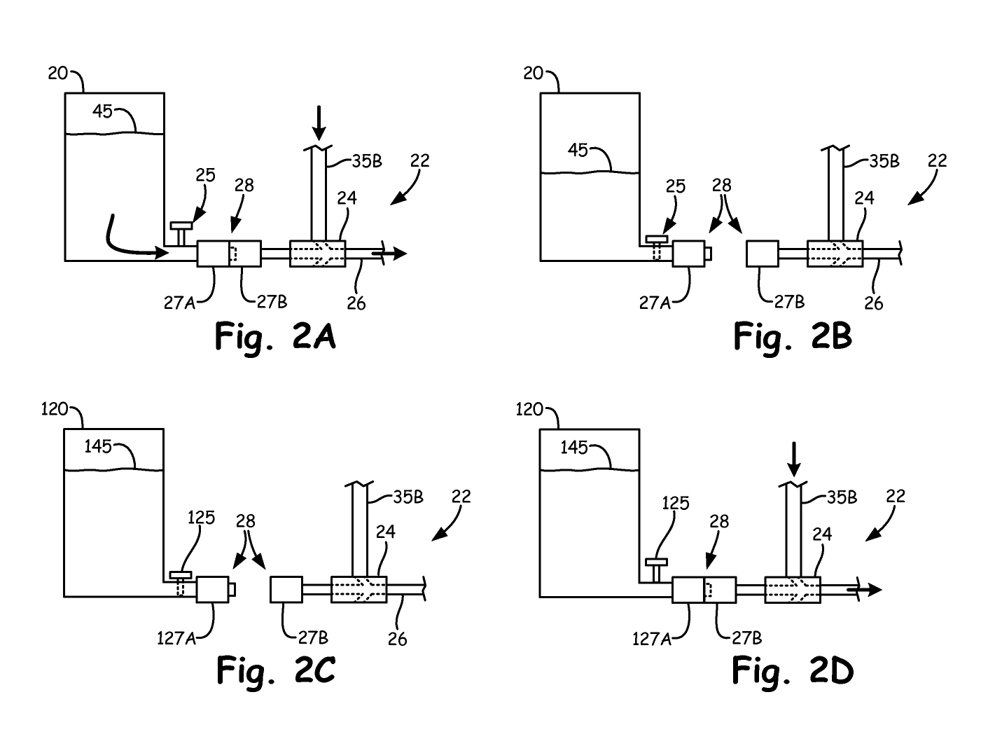

FIG. 2A shows hopper 20 with valve 25 open and coupling 28 connecting hopper 20 to feed system 22. Hopper 20 is shown containing a quantity of solid adhesive pellets 45 which are illustrated being fed through an outlet in a lower portion of hopper 20. Solid adhesive pellets 45 travel past valve 25 and through coupling 28 to vacuum assembly 24. Flow of solid adhesive pellets from hopper 20 through vacuum assembly 24 to melt system 30 is induced by vacuum assembly 24. In particular, vacuum assembly 24 utilizes air supplied by air hose 35B in operation and causes a pressure differential within hopper 24 and feed system 22, which causes solid adhesive pellets 45 to be drawn to and through vacuum assembly 24 down feed hose 26.

During operation, valve 25 is open to allow for the flow of solid adhesive pellets 45 from hopper 20. Valve 25 is positioned near an outlet of hopper 20. Valve 25 is illustrated as a gate valve but can comprise any device capable of regulating the flow of solid adhesive pellets 45. For example, ball valves, butterfly valves, and/or petcock valves may also be used. Valve 25 can be manually operated or actuated by other means.

First coupling part 27A is positioned on or adjacent hopper 20 and is adapted to mate with second coupling part 27B of feed system 22 to comprise coupling 28. First coupling part 27A can be rapidly connected to or disconnected from second coupling part 27B. Thus, first coupling part 27A is releasable from and attachable to second coupling part 27B. Coupling parts 27A and 27B can comprise any coupling capable of quick connection and disconnection with minimum tools. For example, coupling parts 27A and 27B can utilize sleeves, clamps, bayonets, snap-lock, interlock, threads, magnets, quick-disconnect, male/female or similar connections to form coupling 28.

In one embodiment, vacuum assembly 24 operates as a Venturi vacuum. In particular, vacuum assembly 24 utilizes the Venturi effect to produce a vacuum by forcing compressed air from air line 35B through a limiting orifice into the main channel of valve through which solid adhesive pellets 45 pass. When the compressed air passes through that orifice, the air expands, increasing in velocity and imparting a velocity to solid adhesive pellets 45. Additionally, vacuum assembly 24 induces flow of solid adhesive pellets 45 from hopper 20 to vacuum assembly 24. In other embodiments, flow of solid adhesive pellets 45 to feed hose 26 can be induced by other known means such as, for example, augers or pumps.

FIG. 2B shows hopper 20 with coupling 28 disengaged such that hopper 20 is disconnected and removed from feed system 22. Valve 25 has been moved to a closed position to stop solid adhesive pellets 45 from leaving hopper 20 through outlet at first coupling part 27A. Feed assembly 22 comprising second coupling part 27B, vacuum assembly 24, feed hose 26, and air hose 35B has been shut down from operation. Thus, no air travels through air hose 35B to vacuum assembly 24 and no solid adhesive pellets 45 and air travel down feed hose 26.

Once disconnected as illustrated, hopper 20 can be moved by personnel to be more easily refilled with solid adhesive pellets 45 or can be emptied and refilled with a different type of solid adhesive pellets, for example, EVA can be substituted for metallocene. Alternatively, a second different hopper can be coupled to second coupling part 27B.

FIG. 2C shows second hopper 120 with coupling 28 disengaged such that hopper 120 is disconnected and removed from feed system 22. As with the embodiment of first hopper 20 in FIG. 2B, valve 125 has been moved to a closed position to stop solid adhesive pellets 145 from leaving hopper 120 through outlet at first coupling part 127A. Feed assembly 22 comprising second coupling part 27B, vacuum assembly 24, feed hose 26, and air hose 35B has been shut down from operation. Thus, no air travels through air hose 35B to vacuum assembly 24 and no solid adhesive pellets 145 and air travel down feed hose 26.

As illustrated in FIG. 2C, second hopper 120 is similar in size to and utilizes similar components as first hopper 20. However, in other embodiments, second hopper 120 may differ in these and other respects. For example, second hopper 120 may be larger or utilize a different type or location of valve. However, coupling 127A is substantially similar to coupling 27A (FIGS. 2A and 2B) to facilitate quick and easy connection and disconnection of coupling part 127A to second coupling part 27B. Second hopper 120 can be prefilled with solid adhesive pellets 145 and moved adjacent feed assembly 22 prior to disconnection of first hopper 20 from feed assembly 22 in order to facilitate more rapid change over.

FIG. 2D shows second hopper 120 with coupling 28 engaged such that hopper 120 is connected to feed system 22. Valve 125 is open in order to allow solid adhesive pellets 145 to travel to vacuum assembly 24 and then on through feed hose 26, which are illustrated as operational.

In particular, solid adhesive pellets 145 travel past valve 125 and through coupling 28 to vacuum assembly 24. As with the embodiment of FIG. 2A, flow of solid adhesive pellets 145 from hopper 120 through vacuum assembly 24 to melt system 30 is induced by vacuum assembly 24. In particular, vacuum assembly 24 utilizes air supplied by air hose 35B in operation and causes a pressure differential between hopper 24 and feed system 22, which causes solid adhesive pellets 145 to be drawn to and through vacuum assembly 24 down feed hose 26.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims.

1. An adhesive melt system comprising:
a hopper for storing hot melt pellets;
a feed system for delivering hot melt pellets from the hopper;
a valve for regulating movement of the pellets from the hopper to the feed system; and
a releasable coupling that allows for connection and disconnection of the hopper to and from the feed system.

2. The assembly of claim 1, further comprising a flow inducer disposed on the feed assembly for inducing a flow of the hot melt pellets.

3. The assembly of claim 2, wherein the flow inducer comprises:
a Venturi for creating a low pressure zone for inducing flow of hot melt pellets from the hopper into the feed system.

4. The assembly of claim 1, wherein the valve is positioned between a main chamber, an outlet and an outlet through which the hot melt pellets can exit the hopper, and the releasable coupling.

5. The assembly of claim 4, wherein the valve is positioned in the hopper between the main chamber and the outlet.

6. The assembly of claim 1, wherein the valve is set in a closed position when the coupling is disengaged and the hopper is disconnected from the feed assembly, and wherein the valve is set in an open position when the coupling is engaged and the hopper is connected to the feed assembly.

7. An adhesive melt system comprising:
an interchangeable first hopper and second hopper for storing hot melt pellets;
a feed system for delivering the hot melt pellets from either the first hopper or the second hopper; and
a coupling that allows for connection and disconnection of both the first hopper and second hopper to and from the feed system.

8. The system of claim 7, further comprising:
a valve for regulating movement of the hot melt pellets from the first hopper and the second hopper.

9. The system of claim 8, wherein the valve positioned between a main chamber and an outlet of each of the first hopper and second hopper.

10. The system of claim 7, further comprising further comprising a flow inducer disposed on the feed system for inducing a flow of the hot melt pellets.

11. The system of claim 7, wherein the first hopper stores a different type of hot melt pellets than the second hopper.

12. A method of operating a hot melt dispensing system, the method comprising:
attaching a first hopper to a delivery line;
opening a valve to allow hot melt pellets from the first hopper to flow to the delivery line;
delivering the hot melt pellets from the delivery line to a melter;
closing the valve;
disconnecting the first hopper from the delivery line;
attaching a second hopper to the delivery line;
opening a second valve to allow hot melt pellets from the second hopper to travel to the delivery line; and
delivering the hot melt pellets from the delivery line to the melter.

13. The method of claim 12, further comprising inducing a flow of the hot melt pellets along the delivery line.

14. The method of claim 12, wherein attaching both the first hopper to the delivery line and the second hopper to the delivery line is facilitated by a releasable coupling.

15. The method of claim 12, wherein the valve is set in a closed position when the coupling is disengaged and the hopper is disconnected from the delivery line, and wherein the valve is set in an open position when the coupling is engaged and the hopper is connected to the delivery line.

16. An adhesive melt system comprising:
a hopper for storing hot melt pellets and having a valve for regulating movement of the pellets from the hopper;
a delivery line for delivering the hot melt pellets from the hopper;
a flow inducer disposed on the delivery line for inducing a flow of the hot melt pellets along the delivery line; and
a releasable coupling that allows for connection and disconnection of the hopper to and from the delivery line.

17. The assembly of claim 16, wherein the flow inducer comprises:
a Venturi for creating a low pressure zone for inducing flow of hot melt pellets from the hopper into the delivery line.

18. The assembly of claim 16, wherein the valve is positioned between a main chamber and an outlet through which the hot melt pellets can exit the hopper.

19. The assembly of claim 16, wherein the valve is set in a closed position when the coupling is disengaged and the hopper is disconnected from the delivery line, and wherein the valve is set in an open position when the coupling is engaged and the hopper is connected to the delivery line.
